(19) United States
(12) Patent Application Publication
(10) Pub. No.: US 2011/0122538 A1
(43) Pub. Date: May 26, 2011

(54) Apparatus for Shutting Off a Fault Current in a Current-Carrying Line

(76) Inventor: Reinhard Maier, Herzogenaurach (DE)

(21) Appl. No.: 13/054,352

(22) PCT Filed: Jul. 20, 2009
(86) PCT No.: PCT/EP2009/059291

§ 371 Date: Jan. 14, 2011

(30) Foreign Application Priority Data
Jul. 25, 2008 (DE) 10 2008 034 684.5

(51) Int. Cl. H02H 3/42

(52) U.S. Cl. 361/79

(57) ABSTRACT

A trigger is provided for switch closing of a dynamic switch that opens under current flow, the trigger being based on a measurement of the current flowing through the switch during burning of an arc. The voltage of the arc is measured or is approximated using an approximation formula for the voltage, and the power is calculated. The power or integrated power, i.e. the energy, through the switch is applied for the triggering.

### CROSS-REFERENCE TO RELATED APPLICATIONS

This application is a U.S. National Stage Application of International Application No. PCT/EP2009/059291 filed Jul. 20, 2009, which designates the United States of America, and claims priority to DE Application No. 10 2008 034 684.5 filed Jul. 25, 2008. The contents of which are hereby incorporated by reference in their entirety.

### TECHNICAL FIELD

The invention relates to an arrangement for shutting off a fault current in a current-carrying line. The arrangement comprises a switching element for disconnecting the line and at least one actuator for triggering disconnection. The invention also relates to a method for shutting off a fault current in a current-carrying line using a switching element in the line.

### BACKGROUND

Such an arrangement for shutting off a fault current, in particular a short-circuit current, is usually provided in a three-phase system, in particular a three-phase power supply system. In this case, the arrangement has three switching elements. However, such arrangements may also be provided in energy distribution systems comprising a single current-carrying conductor in conjunction with a neutral conductor. In this case, the arrangement may comprise one or two switching elements.

The switching elements in the arrangement must give rise to very early contact separation of their respective switching contacts in the event of a short circuit in order to rapidly build up an arc voltage which limits the short-circuit current. Algorithms for rapidly detecting short circuits as well as rapid tripping systems, electrodynamic opening forces and rapid running of the arc are used for this purpose.

The current-carrying conductor tracks which conduct the current to a respective switching contact of a switching element are designed in such a manner that the flowing currents produce a lifting-off force on the contact. This is referred to as “current lifting-off forces”. The advantage of this implementation is that the lifting-off force is achieved without delay when high currents occur. However, current lifting-off forces generally do not suffice on their own to completely disconnect the contact of the switching element.

### SUMMARY

According to various embodiments, an arrangement for rapidly shutting off a fault current can be specified, which arrangement makes it possible to rapidly disconnect the relevant current-carrying lines in a simple, cost-effective and rapid manner when a short circuit occurs, in particular when a short circuit is present. According to further embodiments, a method for rapidly shutting off a fault current having the same advantages can be specified.

According to an embodiment, an arrangement for shutting off a fault current in a current-carrying line, may comprise a switching element for disconnecting the line, at least one actuator for triggering disconnection, and a device for detecting an arc in the switching element and for driving the actuator in the event of a detected arc, the device having first means for measuring the current through the switching element and second means for determining a value representing the voltage across the switching element.

According to a further embodiment, the device can be configured to carry out the tripping operation on the basis of the product of the current and the value representing the voltage. According to a further embodiment, the device can be configured to carry out the tripping operation on the basis of a sum of products of the current and the value representing the voltage at least two points in time. According to a further embodiment, the second means may comprise elements for measuring the voltage across the switching element. According to a further embodiment, the second means can be configured to form the value from an assumed voltage, the assumed voltage being the product of the current and a resistance which increases exponentially with time. According to a further embodiment, the device can be configured to determine a starting time for the resistance which increases exponentially with time by comparing the current with a current threshold value. According to a further embodiment, the device may comprise elements for measuring the voltage across the switching element and is configured to determine a starting time for the resistance which increases exponentially with time by measuring the voltage across the switching element. According to a further embodiment, can be configured in such a manner that a current flowing through the switching element gives rise to a lifting-off force on contacts of the switching element, which force results in the contacts being disconnected in the event of an overcurrent.

According to another embodiment, a switch may have at least one arrangement as described above.

According to yet another embodiment, a method for shutting off a fault current in a current-carrying line using a switching element in the line, may comprise that the current through the switching element is measured, a value representing the voltage across the switching element is determined, a rated value is determined from the current and the value representing the voltage, the rated value is compared with a threshold value, and disconnection of the line by the switching element is triggered on the basis of the comparison result.

According to a further embodiment of the method, the product of the current and the value representing the voltage can be used as the rated value. According to a further embodiment of the method, a sum of products of the current and the value representing the voltage at least two points in time can be used as the rated value. According to a further embodiment of the method, in order to determine the value representing the voltage across the switching element, the voltage across the switching element can be measured. According to a further embodiment of the method, in order to determine the value representing the voltage across the switching element, the value can be formed from an assumed voltage, the assumed voltage being the product of the current and a resistance which increases exponentially with time. According to a further embodiment of the method, a starting time for the resistance which increases exponentially with time can be determined by comparing the current with a current threshold value or by measuring the voltage across the switching element and comparing it with a voltage threshold value.

### BRIEF DESCRIPTION OF THE DRAWINGS

Preferred, but in no way restrictive, exemplary embodiments are now explained in more detail using the drawing. In the drawing, certain features are illustrated only schematically and corresponding parts in the figures are provided with the same reference symbols. In this case, in detail

FIG. 1 shows a circuit diagram of a switch having a power tripping device with measurement of the switching path voltage,

FIG. 2 shows a circuit diagram of a switch having an energy tripping device with measurement of the switching path voltage,

FIG. 3 shows a circuit diagram of a switch having a power tripping device in which an exponentially increasing arc resistance is taken into account,

FIG. 4 shows a circuit diagram of a switch having an energy tripping device in which an exponentially increasing arc resistance is taken into account,

FIG. 5 shows a circuit diagram of a switch having a power tripping device in which an exponentially increasing arc resistance is taken into account and the switching path voltage is measured,

FIG. 6 shows a circuit diagram of a switch having an energy tripping device in which an exponentially increasing arc resistance is taken into account and the switching path voltage is measured.

### DETAILED DESCRIPTION

The arrangement according to various embodiments for shutting off a fault current in a current-carrying line comprises a switching element for disconnecting the line and at least one actuator for triggering disconnection. A device for detecting an arc in the switching element and for driving the actuator in the event of a detected arc is also provided. The device in turn has first means for measuring the current through the switching element. Finally, the device has second means for determining a value representing the voltage across the switching element.

In the method according to various embodiments for shutting off a fault current in a current-carrying line using a switching element in the line:

the current through the switching element is measured,

a value representing the voltage across the switching element is determined,

a rated value is determined from the current and the value representing the voltage,

the rated value is compared with a threshold value, and

disconnection of the line by the switching element is triggered on the basis of the comparison result.

The switching element may be part of a circuit-breaker, in particular a circuit-breaker for low-voltage applications. The switching element is expediently configured in such a manner that its contacts experience a lifting-off force as a result of the flowing current. As a result, the contacts are lifted off from one another in the case of an overcurrent or short-circuit current. This produces an arc which, although allowing the current to initially continue to flow, limits the current intensity. In this case, a corresponding switch, in particular a circuit-breaker, comprises one or more switching elements.

According to various embodiments, the current flowing through the line and thus through the switching element is measured. The current can be measured in different ways. For example, the current can be measured using a current transformer. A Rogowski coil can also be used. It is likewise possible to measure the current at a shunt resistor. The advantage of the transformer-based taps, that is to say the current transformer or Rogowski coil, is the automatic DC isolation from the possibly high voltage present on the line.

According to various embodiments, a value representing the voltage across the switch is used. This value is combined with the measured current in order to trigger disconnection of the contacts of the switching element. For example, a rated value can be determined from the current and the value representing the voltage. The rated value is in turn compared with a threshold value. In this case, overshooting—or undershooting, depending on the specific configuration of the calculation—results in disconnection, that is to say tripping of the latch, for example.

According to various embodiments, recourse is thus advantageously had only to electrical variables in order to determine a tripping criterion. Other physical variables, for example the increase in pressure caused by the arc or the like, need not be determined.

The instantaneous value of the electrical power across the switch can be used as the rated value, for example. When the switch is closed, the power will be virtually zero. However, if the arc burns with slight separation of the contacts of the switch from one another, a flow of current is established via the switch in the case of an arc voltage, the two values being highly variable over time. The electrical power consumed in the switch is known to be calculated as the product of the current and the value representing the voltage. If the instantaneous power value is used in the tripping device as the tripping criterion, that is to say the comparison with the threshold value, it is a power-based tripping device.

Alternatively, an energy-based tripping device can be implemented by forming the rated value with a sum of products of the current and the value representing the voltage at at least two points in time. In other words, a plurality of (at least two) values of the instantaneous power, for example, are thus added in order to obtain the criterion for tripping the switch. Integrating a plurality of power values produces a value representing the total energy converted in the arc.

The instantaneous power value or its sum and the integral of the power have the advantage of being electrical and physical variables which can be directly detected and compared. However, it is also possible, according to various embodiments, to calculate other variables with the aid of other formulas as the product of the current and voltage.

The value representing the voltage can be ascertained or determined in various ways. On the one hand, a measurement of the voltage across the switch lends itself for this purpose. This has the advantage that the value always corresponds to the voltage actually present. Unforeseen events which possibly occur when the switch is opened are thus detected, if possible, via the current and voltage. The voltage can be measured in many ways. Taps are preferably routed from both sides of the switch into a rectifier, for example a known bridge rectifier having four diodes. As a result, only the magnitude of the voltage is determined since the polarity is of no interest to the tripping device. The voltage determined is preferably transmitted to the other components of the tripping device in a DC-isolated manner. A series resistor and a light-emitting diode may be used, for example, in the rectifier for this purpose, as a result of which the measured voltage is transmitted on the basis of the luminous intensity.

A further embodiment for measuring the voltage involves forming the value representing the voltage from an assumed (arc) voltage. In this case, the assumed voltage is the product of the current which is measured anyway and a resistance which increases exponentially with time. The following assumed profile of the voltage across the switch, that is to say the arc voltage, is thus assumed:

U_{B}(t)=i(t)·a·e^{b·(t-t0)}.

In this case, UB(t) is the arc voltage, that is to say the voltage across the switch, i(t) is the measured current and a and b are constants. t0 is a starting time at which the exponential profile begins. In this case, the starting time corresponds approximately to the start time of the arc.

If the instantaneous power p(t)=i(t)*U_{B}(t), for example, is used as the rated value, the following results as the formula for the rated value taking into account the assumed value for the voltage:

p(t)=i²(t)·a·e^{b·(t-t0)}.

The energy can in turn be stated as follows if the starting time t0 is likewise used as the starting time for integration:

$$E ( t ) = {\int }_{t 0}^{t} {i}^{2} ( T ) \cdot a \cdot {e}^{b \cdot ( T - t 0 )} d T .$$

Both the power value and the energy thus depend only on the measured current in terms of the electrical variables. An explicit voltage measurement is thus advantageously not required according to this embodiment in order to calculate the power, energy or other variables formed from the current and voltage.

However, it is expedient to provide a possible way of determining or defining the starting time t0. According to an embodiment, a current threshold value is defined for this purpose. The time at which the measured current overshoots this threshold value is then defined as the starting time t0. The exponential profile of the assumed voltage then begins from this time on. Depending on the actual measured current, the threshold value is subsequently possibly overshot, which results in disconnection of the contacts being triggered.

According to an alternative embodiment, the starting time is defined by a voltage measurement. The voltage measurement already described further above, for example, can be used for this purpose, the voltage determined being used in this case to define the starting time. In this refinement, the voltage need not necessarily be transmitted as an analog value. Rather, it is sufficient to forward an indication which signals a voltage which is clearly different from zero, for example.

The electrical and electronic components of the tripping device are expediently supplied in such a manner that a sufficiently rapid response of the tripping device is possible even when the switch is switched on in the event of a fault. According to an embodiment, a power supply unit is provided in conjunction with the means of the tripping device for this purpose. The power supply unit has a charging time of preferably less than 0.1 ms.

There are a whole series of possibilities for the specific implementation of the described components of the tripping device. According to an embodiment, the means are constructed as analog circuit components. In addition to the bridge rectifier comprising diodes as well as the series resistor and the light-emitting diode for optical coupling, operational amplifiers are used in this case. In this case, the exponential profile of the assumed voltage may likewise be analog. According to a further embodiment, the calculation of the power using the assumed arc voltage is logarithmized. The following then results as the formula for the instantaneous power value:

ln[p(t)]=2·ln[i(t)]+ln a+b·(t−t0).

There is thus no longer any need to represent an exponential signal with an analog component. The measured current value must now be logarithmized for this purpose. A commercially available logarithmizer with temperature compensation can be used in this case, for example. The remaining operations can be implemented in a comparatively simple manner using operational amplifiers.

According to an alternative embodiment, the means, that is to say the various calculations and comparisons, are implemented in digital form. A module, for example a CPLD or an FPGA, can be used for this purpose. The measured current value and, if appropriate, the measured voltage value are digitized using an A/D converter and are processed further by the digital module. It is naturally also possible to mix the two possibilities, analog and digital.

It is particularly advantageous if the switch already has a digital control module, for example a so-called electronic trip unit (ETU), and the means of the tripping device are integrated in the latter. This is because various embodiments can thus be at least partially implemented using hardware which already exists.

The common feature of all of the structures described below is that there is a circuit-breaker 1. The circuit-breaker 1 is configured in such a manner that its contacts open dynamically on the basis of the current in the event of an overcurrent. If this happens, an arc is produced and allows current to continue to flow for a certain amount of time. The circuit-breaker 1 has an actuator which is not diagrammatically illustrated and definitively disconnects the contacts of the switch. The function of the actuator can be seen in the dotted line to the circuit-breaker 1.

Furthermore, a current transformer 2 is provided in all structures on one of the supply lines to the circuit-breaker 1. This current transformer makes it possible to determine the current flowing through the supply line and thus through the circuit-breaker 1. In the examples given, the current transformer 2 is intended to be a transformer-based current transformer 2. Alternatively, a Rogowski coil can also be used, for example.

Furthermore, all of the structures have a power supply unit 6 which is connected to the current transformer 2 in these examples. The power supply unit 6 obtains its energy via the current transformer 2. It is used to electrically supply the tripping device described below. In this case, it is expedient if the power supply unit 6 has a charging time of less than 0.1 ms, for example. Only if the electronics of the tripping device are ready for use in a sufficiently rapid manner is it also possible to ensure that the latter responds directly in the event of a fault upon being switched on.

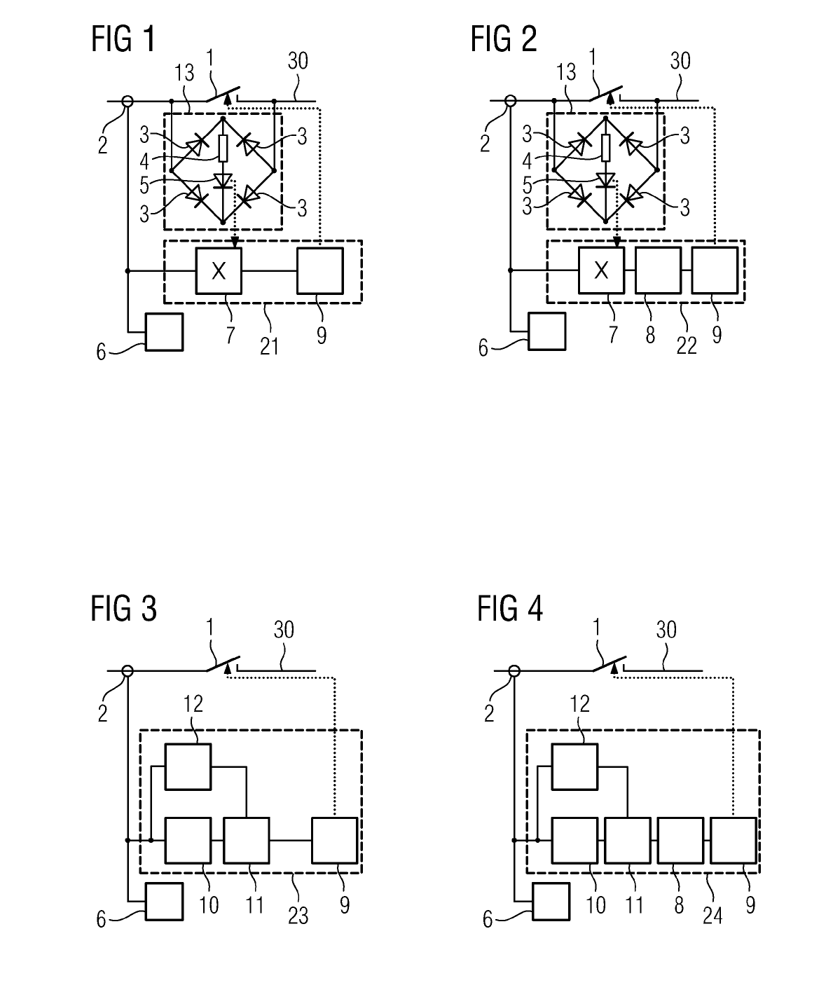

In addition to the components already mentioned, the first exemplary embodiment according to FIG. 1 now has a device for measuring the voltage 13 across the switching path. For this purpose, a respective tap is provided on both sides of the circuit-breaker 1 and leads to a bridge rectifier comprising four diodes 3. The rectifier results in only the magnitude of the voltage across the circuit-breaker 1 being determined. On the output side, the rectifier is connected to a series resistor 4 and to a light-emitting diode 5. The series resistor is known to be used to operate the light-emitting diode 5. The light-emitting diode 5 emits according to the instantaneous absolute voltage value.

Since both the measurement of the current and the forwarding of the voltage measured across the circuit-breaker 1 are carried out in a DC-isolated manner, the rest of the tripping device may be effected in a potential-isolated manner from the circuit-breaker 1 and its supply lines.

The tripping device also has first electronics 21 containing a multiplier 7 and a comparison unit 9. The first electronics 21 receive the current value and the voltage value transmitted from the LED 5. The multiplier 7 is used to determine the product of the measured current and the measured voltage, that is to say the instantaneous power consumed in the circuit-breaker 1. In the case of a closed circuit-breaker 1, this power will be close to zero since the voltage across the switch is very low. An arc is produced when the circuit-breaker 1 is opened dynamically on the basis of the current. In this state, the voltage across the circuit-breaker 1 will increase considerably. The comparison unit 9 determines whether the product of the measured current and voltage, that is to say the arc voltage, overshoots a predefined threshold value. If this happens, the actuator is used and the circuit-breaker 1 is thus opened rapidly and completely.

The first exemplary embodiment according to FIG. 1 is a power-based tripping device. Only the instantaneous power values are taken into account in order to trip the latch. An energy-based tripping device according to an alternative, second exemplary embodiment is illustrated in FIG. 2.

The second exemplary embodiment contains the same components as the first embodiment variant according to FIG. 1. The instantaneous power values are still calculated here from the instantaneous current and voltage values. However, the second electronics 22 used in the second exemplary embodiment additionally have a summing unit 8 which adds or integrates the instantaneous power values. The total energy converted in the circuit-breaker 1 is thus determined from the instantaneous power values in the electronics used in the second exemplary embodiment.

In addition to the current measurement, the tripping devices according to the first two exemplary embodiments also have a voltage measurement 13. The actual value of the arc voltage is thus always determined. The next four embodiment variants take a different approach. In this case, the voltage is not measured in order to determine the instantaneous power value. Instead, it is assumed that the voltage across the circuit-breaker 1, that is to say the arc voltage, follows an exponential profile over time as soon as the arc has started to burn. The arc voltage U_{B} can be estimated using the following formula, where a and b are constants to be defined:

U_{B}(t)=i(t)·a·e^{b·(t-t0)}.

The arc voltage thus follows the product of the flowing current i(t) and a term that increases exponentially over time.

The power p=U_{B}(t)*i(t) is then:

p(t)=i²(t)·a·e^{b·(t-t0)}.

An instantaneous value for the power can thus be determined on the basis of the measured current without carrying out a voltage measurement for this purpose. With this approach, it is necessary to define or determine a starting time t0 for the exponential profile for this purpose. There are different possibilities for this purpose which are described using the third to sixth exemplary embodiments.

In the third exemplary embodiment illustrated in FIG. 3, the components already described at the outset are provided again. However, the third electronics 23 of the tripping device now comprise a logarithmizing element 10 and a power calculation unit 11. A starter 12 and the comparison unit 9 are also provided. The third electronics 23 take into account the fact that, in analog circuit technology, it is easier to implement the power formula stated above if it is logarithmized:

ln[p(t)]=2·ln[i(t)]+ln a+b·(t−t0).

The measured current is logarithmized in the logarithmizing unit 10 and is used, together with the constants ln(a) and b, in the power calculation unit 11 to calculate the instantaneous power. The starting time t0 is defined by the starter 12. In the third exemplary embodiment, the starter 12 checks whether the current overshoots a threshold value. If this happens, the starter 12 forwards a corresponding signal to the power calculation unit 11 which then defines the starting time t0 as the instantaneous time and thus allows the b*(t−t0) to start to run.

The comparison unit 9 in turn checks whether the logarithmized instantaneous power value overshoots a predefined threshold value. The threshold value is also expediently logarithmized, with the result that the instantaneous power value does not have to be converted into the power value again, for instance.

Since the instantaneous power value is used for the comparison with the threshold value in this case, the third embodiment variant according to FIG. 3 is again a power-based tripping device.

FIG. 4 shows a tripping device which is constructed in a similar manner to the third exemplary embodiment but operates in an energy-based manner. In this fourth embodiment option, a summing unit 8 is again added only to the fourth electronics 24. Said unit adds or integrates the instantaneous power values and uses them to calculate the total energy converted in the circuit-breaker 1.

A fifth embodiment option and a sixth embodiment option result if the starting time for the b*(t−t0) ramp is defined using the actual voltage across the switching path rather than the current. For this purpose, it is again necessary to measure the voltage, as in the first and second exemplary embodiments.

FIG. 5 shows the fifth exemplary embodiment. The fifth electronics 25 in the fifth exemplary embodiment largely correspond to those in the third exemplary embodiment. The fifth electronics differ from those in the third exemplary embodiment in that the starter 12 in the third embodiment variant has been replaced with the voltage measurement 14. However, in this instance, the measured voltage is not directly incorporated in the determination of the instantaneous power value. Rather, the measured voltage is used to determine the starting time t0. The fifth exemplary embodiment is again a power-based tripping device.

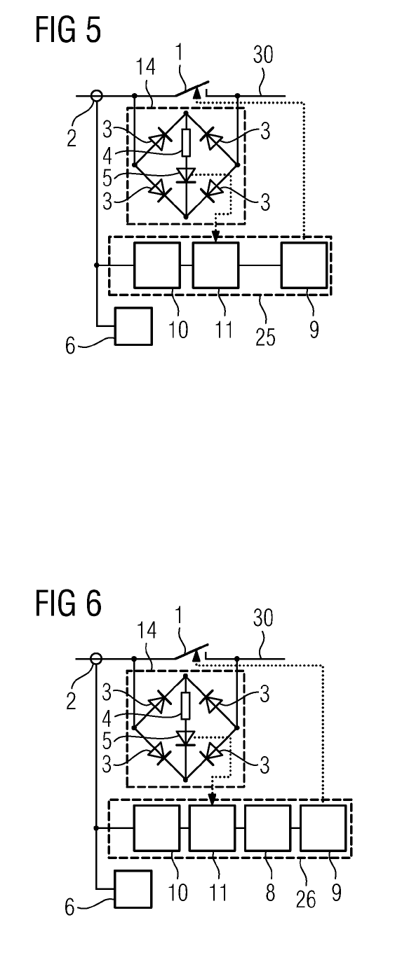

In the sixth exemplary embodiment according to FIG. 6, the sixth electronics 26 again have, in addition to the components according to the fifth exemplary embodiment, a summing unit 8 which adds or integrates the instantaneous power values. The tripping device according to the sixth embodiment variant is thus again an energy-based tripping device.

With respect to all of the exemplary embodiments, it is clear that the components described here can also often be implemented in a manner other than that described. Other embodiments which are sufficiently well known to a person skilled in the art can also be considered for the voltage measurement instead of the bridge rectifier in conjunction with the light-emitting diode.

In particular, however, the electronics 21 . . . 26 of the tripping device, that is to say the elements of the multiplier 7, the summing unit 8, the comparison unit 9, the logarithmizing unit 10, the power calculation unit 11 and the starter 12 which have been divided as function blocks here, permit a number of actual implementations. Said elements can be implemented individually, for example in the form of an analog circuit. On the other hand, it is also possible to implement some or all of the elements in a digital form, for example in the form of a programmable module such as a CPLD. In this case, it is clear that, depending on the implementation, the elements are possibly no longer disconnected as in the present case but rather form a common element in which the corresponding functions are performed together. In a circuit-breaker which already has a digital circuit, for example an electronic trip unit (ETU), it is expedient to integrate some or all of the elements of the tripping device in this ETU.

In the third to sixth exemplary embodiments, logarithmization was also used in order to allow a simpler construction, in particular in the case of analog components. Logarithmizers 10 are commercially available as a circuit and the additional elements can be implemented using operational amplifiers, for example. However, it is also possible to use the values unchanged instead of carrying out logarithmization.

What is claimed is:

1. An arrangement for shutting off a fault current in a current-carrying line, comprising:
a switching element for disconnecting the line,
at least one actuator for triggering disconnection, and
a device for detecting an arc in the switching element and for driving the actuator in the event of a detected arc, the device comprising:
first means for measuring the current through the switching element, and
second means for determining a value representing the voltage across the switching element.

2. The arrangement according to claim 1, wherein the device is configured to carry out the tripping operation on the basis of the product of the current and the value representing the voltage.

3. The arrangement according to claim 1, wherein the device is configured to carry out the tripping operation on the basis of a sum of products of the current and the value representing the voltage at at least two points in time.

4. The arrangement according to claim 2, wherein the second means comprise elements for measuring the voltage across the switching element.

5. The arrangement according to claim 2, wherein the second means are configured to form the value from an assumed voltage, the assumed voltage being the product of the current and a resistance which increases exponentially with time.

6. The arrangement according to claim 5, wherein the device is configured to determine a starting time for the resistance which increases exponentially with time by comparing the current with a current threshold value.

7. The arrangement according to claim 5, wherein the device comprises elements for measuring the voltage across the switching element and is configured to determine a starting time for the resistance which increases exponentially with time by measuring the voltage across the switching element.

8. The arrangement according to claim 1, wherein is configured in such a manner that a current flowing through the switching element gives rise to a lifting-off force on contacts of the switching element, which force results in the contacts being disconnected in the event of an overcurrent.

9. A switch having at least one arrangement according to claim 1.

10. A method for shutting off a fault current in a current-carrying line using a switching element in the line, the method comprising:
measuring the current through the switching element
determining a value representing the voltage across the switching element,
determining a rated value from the current and the value representing the voltage,
comparing the rated value with a threshold value, and
triggering disconnection of the line by the switching element on the basis of the comparison result.

11. The method according to claim 10, wherein the product of the current and the value representing the voltage is used as the rated value.

12. The method according to claim 1, wherein a sum of products of the current and the value representing the voltage at at least two points in time is used as the rated value.

13. The method according to claim 11, wherein, in order to determine the value representing the voltage across the switching element, the voltage across the switching element is measured.

14. The method according to claim 11, wherein, in order to determine the value representing the voltage across the switching element, the value is formed from an assumed voltage, the assumed voltage being the product of the current and a resistance which increases exponentially with time.

15. The method according to claim 14, wherein a starting time for the resistance which increases exponentially with time is determined by comparing the current with a current threshold value or by measuring the voltage across the switching element and comparing it with a voltage threshold value.

16. An arrangement for shutting off a fault current in a current-carrying line, comprising:
a switching element for disconnecting the line,
at least one actuator for triggering disconnection, and
a device for detecting an arc in the switching element and for driving the actuator in the event of a detected arc, the device comprising:
a current sensor measuring the current through the switching element, and
a voltage sensor measuring the voltage across the switching element.

17. The arrangement according to claim 16, wherein the device is configured to carry out the tripping operation on the basis of the product of the current and the value representing the voltage.

18. The arrangement according to claim 16, wherein the device is configured to carry out the tripping operation on the basis of a sum of products of the current and the voltage at at least two points in time.

19. The arrangement according to claim 16, wherein the device is configured to determine a starting time for a resistance which increases exponentially with time by comparing the current with a current threshold value.

20. The arrangement according to claim 16, wherein the device is configured to determine a starting time for a resistance which increases exponentially with time by measuring the voltage across the switching element.
